(19) United States
(12) Patent Application Publication
(10) Pub. No.: US 2013/0312658 A1
(43) Pub. Date: Nov. 28, 2013

(54) SUBSTRATE PROCESSING APPARATUS

(71) Applicants: Masahito KASHIYAMA, Kyoto-shi (JP); Kazuhiro NISHIMURA, Kyoto-shi (JP)

(72) Inventors: Masahito KASHIYAMA, Kyoto-shi (JP); Kazuhiro NISHIMURA, Kyoto-shi (JP)

(21) Appl. No.: 13/892,440

(22) Filed: May 13, 2013

(30) Foreign Application Priority Data
May 24, 2012 (JP) 2012-118827

(51) Int. Cl. B05C 13/00

(52) U.S. Cl. CPC B05C 13/00
USPC 118/58

(57) ABSTRACT

A platform section has an upper platform chamber and a lower platform chamber. Platform units are provided in the upper platform chamber and the lower platform chamber, respectively. A plurality of local arms corresponding to coating processing chambers are provided in the upper platform chamber and the lower platform chamber, respectively. Further, in the upper platform chamber and the lower platform chamber, a plurality of local arms respectively corresponding to a plurality of thermal processing units, a plurality of local arms respectively corresponding to a plurality of adhesion reinforcement processing units and a plurality of local arms respectively corresponding to a plurality of cooling units are provided.

### BACKGROUND OF THE INVENTION

(1) Field of the Invention

The present invention relates to a substrate processing apparatus that performs processing on a substrate.

(2) Description of Related Art

A substrate processing apparatus is used to apply a variety of processing to substrates such as semiconductor substrates, substrates for use in liquid crystal displays, plasma displays, optical discs, magnetic discs, magneto-optical discs, photomasks, and other substrates.

A substrate processing apparatus described in JP 2003-324139 A, for example, has a plurality of processing blocks. A plurality of thermal processing sections, a plurality of chemical solution processing sections and a transport mechanism are provided in each processing block. The transport mechanism performs the transportation of a substrate in each processing block.

### BRIEF SUMMARY OF THE INVENTION

A time period for the transportation of the substrate is required to be shortened in order to improve throughput. In the substrate processing apparatus mentioned in JP 2003-324139 A, operation speed of the transport mechanism needs to be enhanced in order to shorten the time period for the transportation of the substrate. However, there is a limit to how much the operation speed of the transport mechanism can be enhanced. In particular, if the size of the substrate is large, it is more difficult to enhance the operation speed of the transport mechanism because a burden on the transport mechanism is greater.

An object of the present invention is to provide a substrate processing apparatus that can improve throughput.

(1) According to one aspect of the present invention, a substrate processing apparatus includes a processing section and a carry-in/carry-out section for carrying in/out a substrate to/from the processing section, wherein the processing section and the carry-in/carry-out section are arranged in one direction, the processing section includes a liquid processing section for performing liquid processing using a processing liquid on the substrate, a thermal processing section for performing thermal processing on the substrate, a platform section for temporarily placing the substrate, a first transport mechanism configured to transport the substrate between the platform section and the liquid processing section and a second transport mechanism configured to transport the substrate between the platform section and the thermal processing section, and the liquid processing section is arranged on one side of the platform section and the thermal processing section is arranged on another side of the platform section in the one direction and the liquid processing section, the platform section and the thermal processing section are arranged in the one direction, and the carry-in/carry-out section includes a container platform on which a storing container storing the substrate is placed, and a third transport mechanism configured to transport the substrate between the storing container placed on the container platform and the platform section in the processing section.

In the substrate processing apparatus, the processing section and the carry-in/carry-out section are arranged in the one direction. The storing container for storing the substrate is placed on the container platform in the carry-in/carry-out section. The unprocessed substrate is transported from the storing container to the platform section in the processing section by the third transport mechanism. Further, the processed substrate is transported from the platform section in the processing section to the storing container in the carry-in/carry-out section by the third transport mechanism.

The substrate is transported from the platform section to the liquid processing section arranged on the one side of the platform section in the one direction described above by the first transport mechanism. In the liquid processing section, the liquid processing using the processing liquid is performed on the substrate. The substrate after the liquid processing is transported from the liquid processing section to the platform section by the first transport mechanism. Further, the substrate is transported from the platform section to the thermal processing section arranged on the other side of the platform section in the one direction described above by the second transport mechanism. In the thermal processing section, the thermal processing is performed on the substrate. The substrate after the thermal processing is transported from the thermal processing section to the platform section by the second transport mechanism.

Thus, in the processing section, the platform section is arranged between the liquid processing section and the thermal processing section, and the transportation of the substrate between the platform section and the liquid processing section and the transportation of the substrate between the platform section and the thermal processing section are respectively performed by the different first and second transport mechanisms. This enhances transport efficiency of the substrate to the liquid processing section and the thermal processing section. As a result, throughput can be improved.

(2) The platform section may be configured such that the plurality of substrates can be placed one above the other in a vertical direction. In this case, the plurality of substrates can be more efficiently transported to the liquid processing section and the thermal processing section without increasing the occupied area of the platform section.

(3) The liquid processing section may include a plurality of liquid processing units arranged one above the other in a vertical direction. In this case, the liquid processing can be simultaneously performed on the plurality of substrates in the plurality of liquid processing units without increasing the occupied area of the liquid processing section. Thus, the throughput is further improved.

(4) The first transport mechanism may include one or a plurality of first transport units, and each first transport unit may correspond to at least one of the plurality of liquid processing units and may be configured to transport the substrate between the corresponding liquid processing unit and the platform section.

In this case, the substrate can be efficiently transported between the plurality of liquid processing units and the platform section.

(5) At least the one first transport unit may be configured to be vertically movable. In this case, the substrate can be transported between the plurality of liquid processing units and the platform section while the number of the first transport units is reduced. Thus, a cost can be reduced.

(6) The thermal processing section may include a plurality of thermal processing units arranged one above the other in a vertical direction. In this case, the thermal processing can be simultaneously performed on the plurality of substrates in the plurality of thermal processing units without increasing the occupied area of the thermal processing section. Thus, the throughput is further improved.

(7) The second transport mechanism may include one or a plurality of second transport units, and each second transport unit may correspond to at least one of the plurality of thermal processing units and may be configured to transport the substrate between the corresponding thermal processing unit and the platform section.

In this case, the substrate can be efficiently transported between the plurality of thermal processing units and the platform section.

(8) At least the one second transport unit may be configured to be vertically movable. In this case, the substrate can be transported between the plurality of thermal processing units and the platform section while the number of the second transport units is reduced. Thus, the cost can be reduced.

(9) The substrate processing apparatus may further include a lifting/lowering mechanism configured to vertically move the substrate placed in the platform section.

In this case, a height of the substrate placed in the platform section can be adjusted to a height at which the substrate can be received by the first and second transport mechanisms. Thus, the operation of the first and second transport mechanism can be simplified.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a schematic plan view of a substrate processing apparatus according to a first embodiment of the present invention;

FIG. 2 is a schematic side view of a coating processing section, a coating/development processing section and a cleaning/drying processing section;

FIG. 3 is a schematic side view of a thermal processing section and the cleaning/drying processing section;

FIG. 4 is a schematic side view of a platform section;

FIG. 5 is a schematic side view of the coating processing section, the platform section and the thermal processing section;

FIG. 6 is a schematic side view of the coating/development processing section, the platform section and the thermal processing section;

FIGS. 7(a) and 7(b) are schematic plan views of the platform section;

FIG. 8 is a schematic side view of the platform section;

FIG. 9 is a schematic side view of the coating processing section, the platform section and the thermal processing section;

FIG. 10 is a schematic side view of the coating/development processing section, the platform section and the thermal processing section; and

FIGS. 11(a) and 11(b) are schematic plan views of the platform section.

### DESCRIPTION OF THE PREFERRED EMBODIMENTS

A substrate processing apparatus according to embodiments of the invention will be described with reference to the drawings. In the following description, a substrate refers to a semiconductor substrate, a substrate for a liquid crystal display, a substrate for a plasma display, a glass substrate for a photomask, a substrate for an optical disk, a substrate for a magnetic disk, a substrate for a magneto-optical disk, a substrate for a photomask and the like.

### (1) First Embodiment

(1-1) Configuration of the Substrate Processing Apparatus

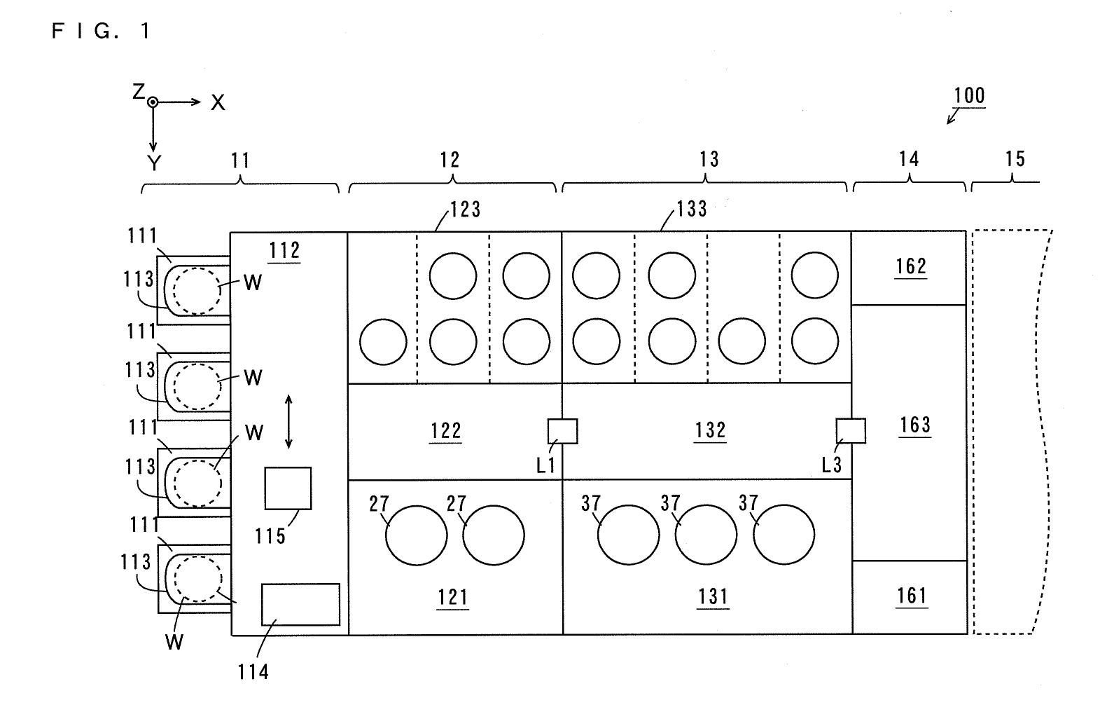

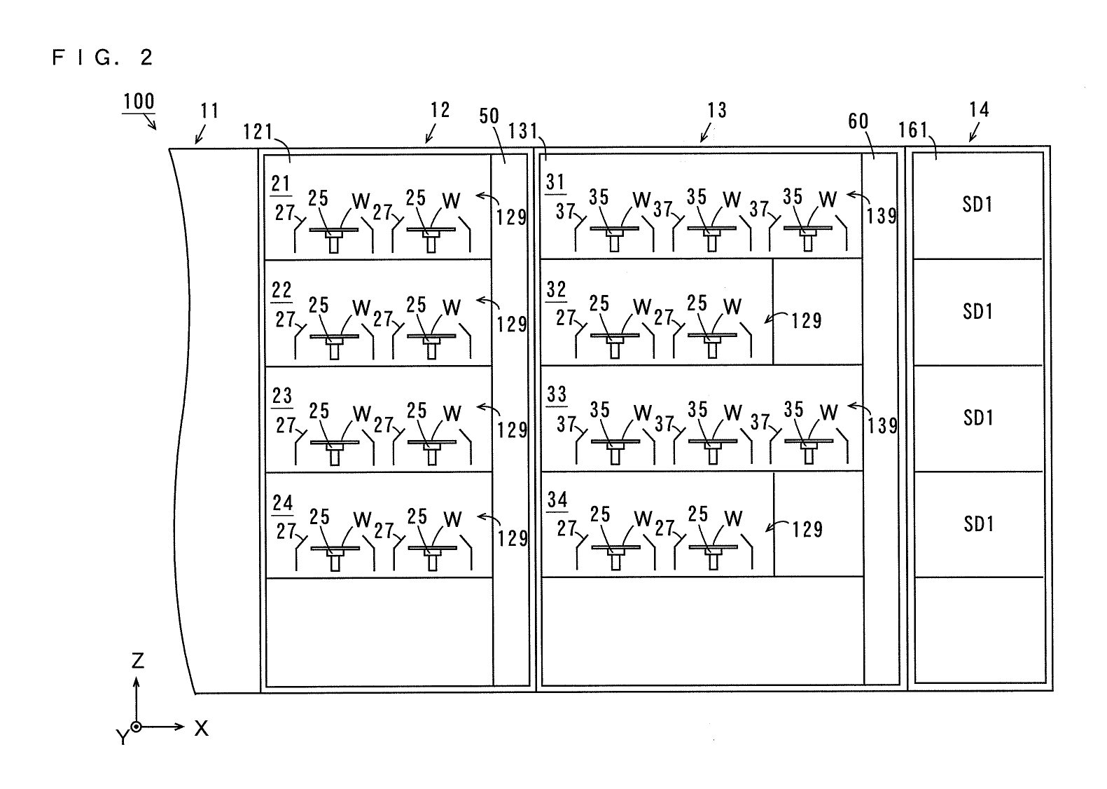

FIG. 1 is a schematic plan view of a substrate processing apparatus according to the first embodiment of the present invention. FIGS. 1, 2 and subsequent given diagrams are accompanied by the arrows that indicate X, Y, and Z directions orthogonal to one another for clarity of a positional relationship. The X and Y directions are orthogonal to each other within a horizontal plane and the Z direction corresponds to a vertical direction.

As shown in FIG. 1, the substrate processing apparatus 100 includes an indexer block 11, a first processing block 12, a second processing block 13 and an interface block 14. The indexer block 11, the first processing block 12, the second processing block 13 and the interface block 14 are arranged in one direction (X direction). An exposure device 15 is arranged to be adjacent to the interface block 14. In the exposure device 15, exposure processing is performed on the substrate W by a liquid immersion method.

The indexer block 11 includes a plurality of carrier platforms 111 and a transport section 112. A carrier 113 storing a plurality of substrates W arranged in multiple stages is placed on each carrier platform 111.

The transport section 112 is provided with a controller 114 and a transport mechanism 115. The controller 114 controls a variety of constituent elements of the substrate processing apparatus 100. The transport mechanism 115 holds and transports the substrate W.

The first processing block 12 includes a coating processing section 121, a platform section 122 and a thermal processing section 123. The coating processing section 121, the platform section 122 and the thermal processing section 123 are provided to be arranged in the Y direction. The coating processing section 121 and the thermal processing section 123 are opposite to each other with the platform section 122 sandwiched therebetween. The coating processing section 121, the platform section 122 and the thermal processing section 123 may be arranged to be misaligned with each other in the Y direction.

The second processing block 13 includes a coating/development processing section 131, a platform section 132 and a thermal processing section 133. The coating/development processing section 131, the platform section 132 and the thermal processing section 133 are provided to be arranged in the Y direction. The coating/development processing section 131 and the thermal processing section 133 are opposite to each other with the platform section 132 sandwiched therebetween. The coating/development processing section 131, the platform section 132 and the thermal processing section 133 may be arranged to be misaligned with each other in the Y direction.

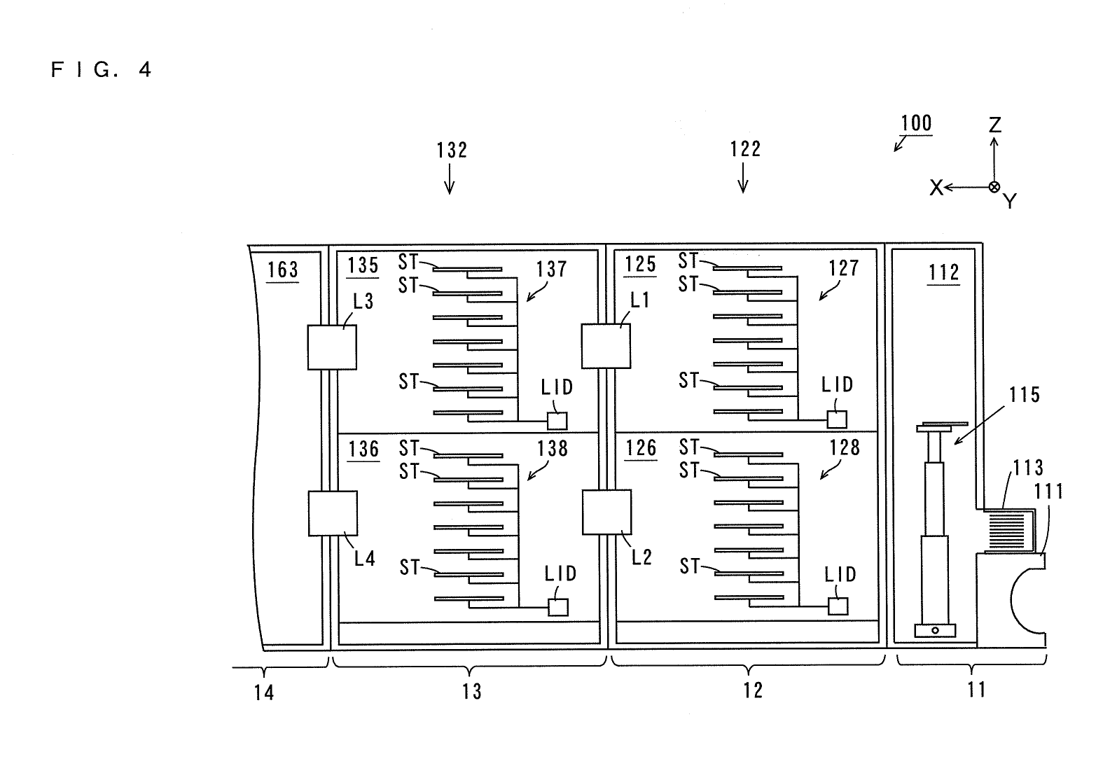

A local arm L1 and a local arm L2 described below (FIG. 4 described below) that holds the substrate W to transport the same are provided between the platform section 122 and the platform section 132.

The interface block 14 includes cleaning/drying processing sections 161, 162 and a transport section 163. The cleaning/drying processing sections 161, 162 are opposite to each other with the transport section 163 sandwiched therebetween. The transport section 163 is provided with a transport mechanism (not shown) for carrying in/out the substrate W to/from the exposure device 15.

A local arm L3 and a local arm L4 described below (FIG. 4 described below) that holds the substrate W to transport the same are provided between the platform section 132 and the transport section 163.

(1-2) Configuration of the Coating Processing Section and the Coating/Development Processing Section

FIG. 2 is a schematic side view of the coating processing section 121, the coating/development processing section 131 and the cleaning/drying processing section 161 of FIG. 1.

As shown in FIG. 2, coating processing chambers 21, 22, 23, 24 are provided in a stack in the coating processing section 121. A coating processing unit 129 is provided in each of the coating processing chambers 21 to 24. Development processing chambers 31, 33 and coating processing chambers 32, 34 are provided in a stack in the coating/development processing section 131. A development processing unit 139 is provided in each of the development processing chambers 31, 33, and a coating processing unit 129 is provided in each of the coating processing chambers 32, 34. Each coating processing unit 129 includes spin chucks 25 that hold the substrates W and cups 27 provided to surround the spin chucks 25. The spin chucks 25 are rotated by a driving device (an electric motor, for example) that is not shown.

In the coating processing unit 129, a processing liquid is discharged on each substrate W held by each spin chuck 25 from a processing liquid nozzle (not shown) such that the processing liquid is applied onto the substrate W. Thus, a film of the processing liquid is formed on the substrate W.

In the present embodiment, an anti-reflection film is formed on the substrate W in each coating processing unit 129 in the coating processing chamber 22, 24. A resist film is formed on the substrate W in the coating processing unit 129 in the coating processing chamber 21, 23. A resist cover film is formed on the substrate W in the coating processing unit 129 in the coating processing chamber 32, 34.

Similarly to the coating processing unit 129, a development processing unit 139 includes spin chucks 35 and cups 37. In the development processing unit 139, a development liquid is supplied onto the substrate W held by each spin chuck 35 from a development liquid nozzle (not shown). Thus, the resist cover film on the substrate W is removed, and the development processing for the substrate W is performed.

While the coating processing unit 129 has two sets of spin chucks 25 and the cups 27, and the development processing unit 139 has three sets of spin chucks 35 and the cups 37 in the example of FIG. 2, these numbers may be suitably changed.

A plurality of (four in this example) cleaning/drying processing units SD1 are provided in a stack in the cleaning/drying processing section 161. In each cleaning/drying processing unit SD1, cleaning processing and drying processing for the substrate W before the exposure processing are performed.

(1-3) Configuration of the Thermal Processing Section

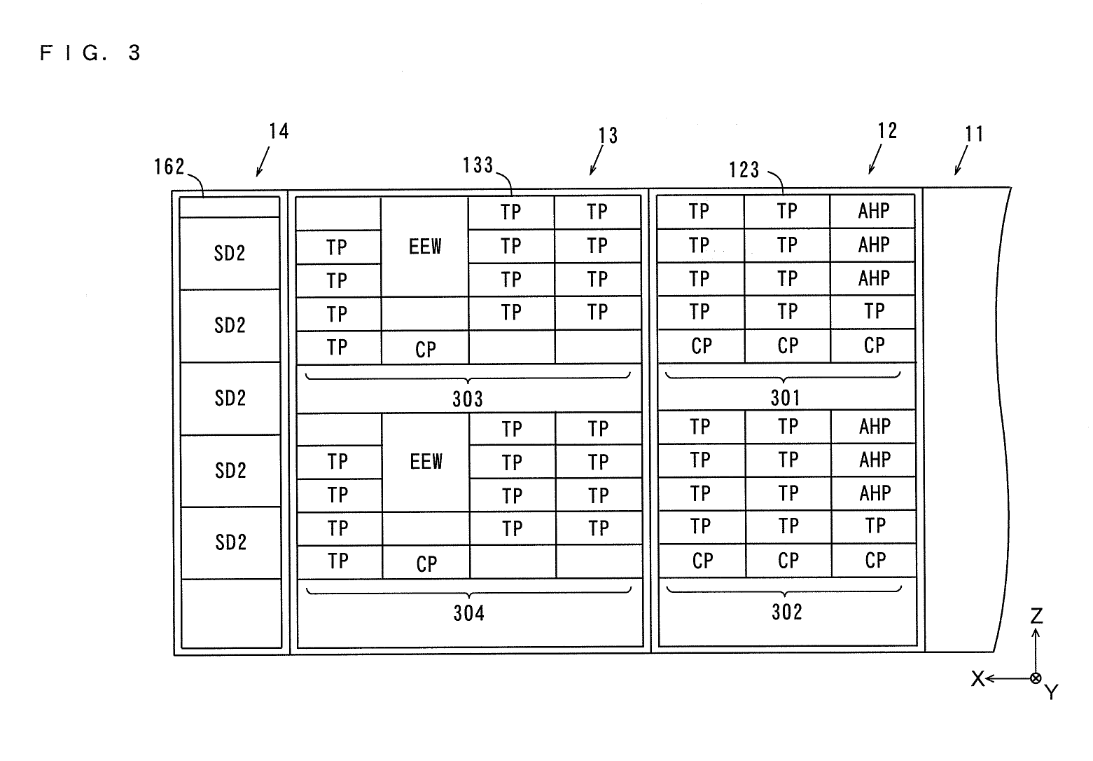

FIG. 3 is a schematic side view of the thermal processing sections 123, 133 and the cleaning/drying processing section 162 of FIG. 1.

As shown in FIG. 3, the thermal processing section 123 has an upper thermal processing section 301 provided above and a lower thermal processing section 302 provided below. Each of the upper thermal processing section 301 and the lower thermal processing section 302 are provided with a plurality of thermal processing units TP, a plurality of adhesion reinforcement processing units AHP and a plurality of cooling units arranged in three rows. Here, a row means an arrangement of the plurality of units in the vertical direction.

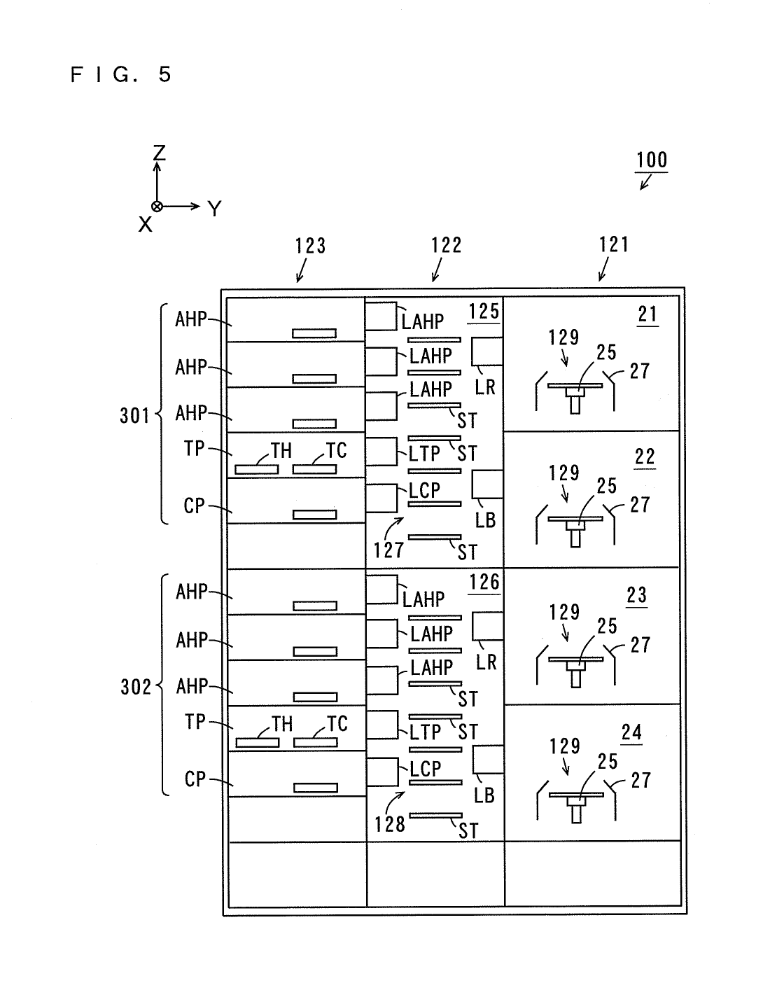

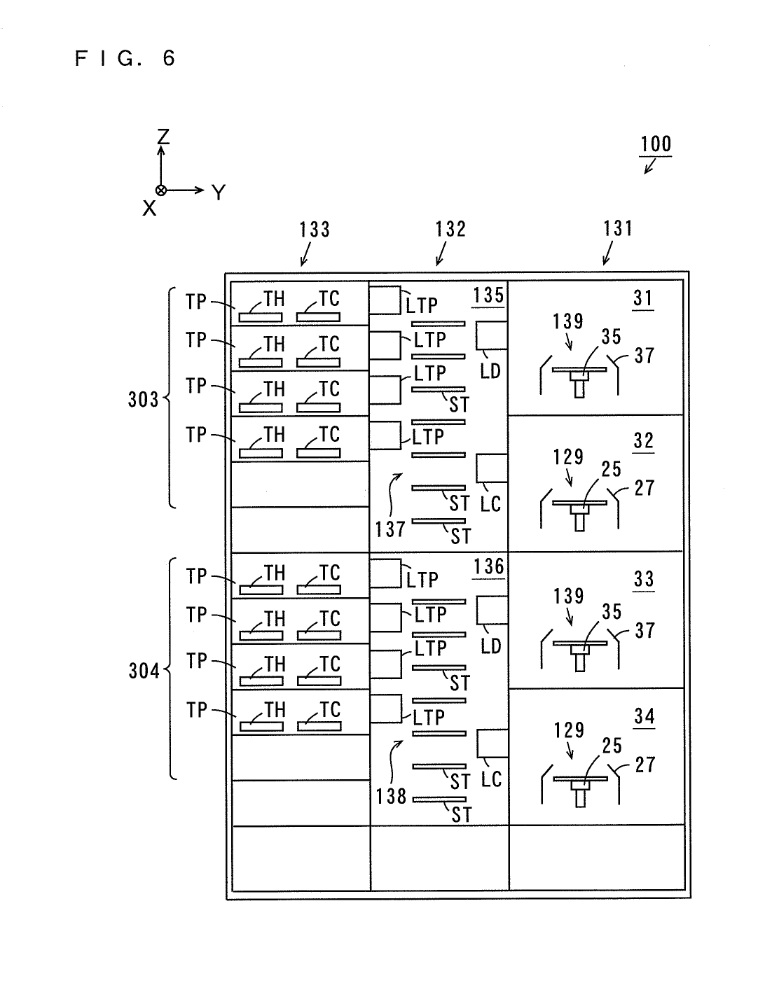

In each thermal processing unit TP, thermal processing for the substrate W is performed. Specifically, the thermal processing for the substrate W by a heating plate TH (FIGS. 5 and 6 described below) and cooling processing for the substrate W by a cooling plate TC (FIGS. 5 and 6 described below) are successively performed. In each adhesion reinforcement processing unit AHP, adhesion reinforcement processing for improving adhesion between the substrate W and the anti-reflection film is performed. Specifically, in the adhesion reinforcement processing unit AHP, an adhesion reinforcement agent such as an HMDS (Hexamethylsilazane) or the like is applied on the substrate W and the heating processing is performed on the substrate W. In each cooling unit CP, the cooling processing for the substrate W is performed.

The thermal processing section 133 has an upper thermal processing section 303 provided above and a lower thermal processing section 304 provided below. Each of the upper thermal processing section 303 and the lower thermal processing section 304 is provided with the plurality of heating processing units TP, an edge exposure unit EEW and the cooling unit CP in four rows.

In the edge exposure unit EEW, the exposure processing for a periphery of the substrate W (edge exposure processing) is performed. This causes the resist film on the periphery of the substrate W to be removed at the time of the subsequent development processing.

A plurality of (five in this example) cleaning/drying processing unit SD2 are provided in the cleaning/drying processing section 162. In the cleaning/drying processing unit SD2, the cleaning processing and the drying processing for the substrate W after the exposure processing are performed.

(1-4) Configuration of the Platform

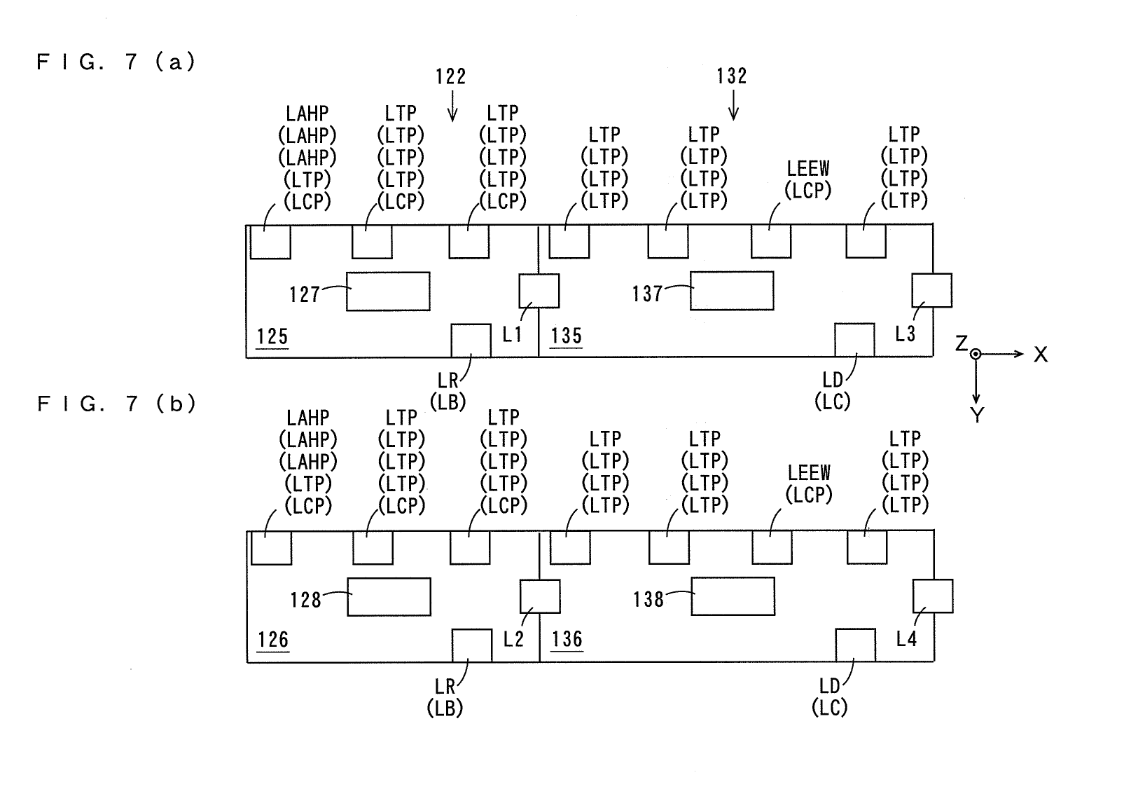

FIG. 4 is a schematic side view of the platform sections 122, 132. FIG. 5 is a schematic side view of the coating processing section 121, the platform section 122 and the thermal processing section 123. FIG. 6 is a schematic side view of the coating/development processing section 131, the platform section 132 and the thermal processing section 133. FIG. 7 is a schematic plan view of the platform sections 122, 132. Note that, FIG. 7(a) shows upper platform chambers 125, 135 described below, and FIG. 7(b) shows lower platforms 126, 136 described below.

As shown in FIG. 4, the platform section 122 has the upper platform chamber 125 and the lower platform chamber 126. The platform section 132 has the upper platform chamber 135 and the lower platform chamber 136. The local arm L1 is provided between the upper platform chamber 125 and the upper platform chamber 135, and the local arm L2 is provided between the lower platform chamber 126 and the lower platform chamber 136. The local arm L3 is provided between the upper platform chamber 135 and the transport section 163 in the interface block 14, and the local arm L4 is provided between the lower platform chamber 136 and the transport section 163 in the interface block 14.

The upper platform chamber 125 is provided with a platform unit 127, and the lower platform chamber 126 is provided with a platform unit 128. Further, the upper platform chamber 135 is provided with a platform unit 137, and the lower platform chamber 136 is provided with a platform unit 138. Each of the platform units 127, 128, 137, 138 includes shelves ST arranged in multiple stages and a lifting/lowering device LID. The substrate W is temporarily placed on each of the shelves ST arranged in multiple stages. The lifting/lowering device LID separately lifts/lowers each of the shelves ST arranged in multiple stages.

As shown in FIG. 5, the coating processing chambers 21, 22 are opposite to the thermal processing section 301 with the upper platform chamber 125 sandwiched therebetween, and the coating processing chambers 23, 24 are opposite to the lower thermal processing section 302 with the lower platform chamber 126 sandwiched therebetween.

The upper platform chamber 125 is provided with a local arm LR corresponding to the coating processing chamber 21 and a local arm LB corresponding to the coating processing chamber 22, and the lower platform chamber 126 is provided with the local arm LR corresponding to the coating processing chamber 23 and the local arm LB corresponding to the coating processing chamber 24. In the upper platform chamber 125, the local arm LR is provided to be adjacent to the coating processing chamber 21, and the local arm LB is provided to be adjacent to the coating processing chamber 22. In the lower platform chamber 126, the local arm LR is provided to be adjacent to the coating processing chamber 23, and the local arm LB is provided to be adjacent to the coating processing chamber 24.

The local arm LR in the upper platform chamber 125 transports the substrate W between the platform unit 127 and the coating processing chamber 21, and the local arm LB in the upper platform chamber 125 transports the substrate W between the platform unit 127 and the coating processing chamber 22. The local arm LR in the lower platform chamber 126 transports the substrate W between the platform unit 128 and the coating processing chamber 23, and the local arm LB in the lower platform chamber 126 transports the substrate W between the platform unit 128 and the coating processing chamber 24.

Each of the local arms LR, LB is configured to be capable of selectively transporting the substrate W onto any of the plurality of spin chucks 25 of the coating processing unit 129. Further, a plurality of local arms LTP respectively corresponding to the plurality of thermal processing units TP, a plurality of local arms LAHP respectively corresponding to the plurality of adhesion reinforcement processing units AHP and a plurality of local arms LCP respectively corresponding to the plurality of cooling units CP are provided in the upper platform chamber 125 and the lower platform chamber 126. In the upper platform chamber 125 and the lower platform chamber 126, each local arm LTP is provided to be adjacent to the corresponding thermal processing unit TP, each local arm LAHP is provided to be adjacent to the corresponding adhesion reinforcement processing unit AHP and each local arm LCP is provided to be adjacent to the corresponding cooling unit CP.

Each local arm LTP in the upper platform chamber 125 transports the substrate W between the platform unit 127 and the corresponding thermal processing unit TP, each local arm LAHP in the upper platform chamber 125 transports the substrate W between the platform unit 127 and the corresponding adhesion reinforcement processing unit AHP and each local arm LCP in the upper platform chamber 125 transports the substrate W between the platform unit 127 and the corresponding cooling unit CP. Each local arm LTP in the lower platform chamber 126 transports the substrate W between the platform unit 128 and the corresponding thermal processing unit TP, each local arm LAHP in the lower platform 126 transports the substrate W between the platform unit 128 and the corresponding adhesion reinforcement processing unit AHP and each local arm LCP in the lower platform chamber 126 transports the substrate W between the platform unit 128 and the cooling unit CP.

Further, each local arm LTP transports the substrate W between the heating plate TH and the cooling plate TC in the corresponding thermal processing unit TP. In this example, the heating plate TH and the cooling plate TC are provided to be arranged in the Y direction in each thermal processing unit TP, the heating plate TH and the cooling plate TC may be arranged one above the other in the vertical direction in an overlapped manner.

When the substrate W is received by each local arm in the upper platform chamber 125 from the platform unit 127, the lifting/lowering device LID of the platform unit 127 (FIG. 4) adjusts a height of the shelf ST such that a height of the substrate W to be received is at the height of which the substrate W can be received by the local arm. Further, when the substrate W is received by the local arm L1 from the platform unit 127, the lifting/lowering device LID of the platform unit 127 (FIG. 4) adjusts a height of the shelf ST such that a height of the substrate W to be received is at the height of which the substrate W can be received by the local arm L1.

As shown in FIG. 6, the development processing chamber 31 and the coating processing chamber 32 are opposite to the upper thermal processing section 303 with the upper platform chamber 135 sandwiched therebetween, and the development processing chamber 33 and the coating processing chamber 34 are opposite to the lower thermal processing section 304 with the lower platform chamber 136 sandwiched therebetween.

The upper platform chamber 135 is provided with a local arm LD corresponding to the development processing chamber 31 and a local arm LC corresponding to the coating processing chamber 32, and the lower platform chamber 136 is provided with the local arm LD corresponding to the development processing chamber 33 and the local arm LC corresponding to the coating processing chamber 34. In the upper platform chamber 135, the local arm LD is provided to be adjacent to the development processing chamber 31, and the local arm is provided to be adjacent to the coating processing chamber 32. In the lower platform chamber 136, the local arm LD is provided to be adjacent to the development processing chamber 33, and the local arm LC is provided to be adjacent to the coating processing chamber 34.

The local arm LD in the upper platform chamber 135 transports the substrate W between the platform unit 137 and the development processing chamber 31, and the local arm LC in the upper platform chamber 135 transports the substrate W between the platform unit 137 and the coating processing chamber 32. The local arm LD in the lower platform chamber 136 transports the substrate W between the platform unit 138 and the development processing chamber 33, and the local arm LC in the lower platform chamber 136 transports the substrate W between the platform unit 138 and the coating processing chamber 34.

The local arm LC is configured to be capable of selectively transporting the substrate W onto any of the plurality of spin chucks 25 of the coating processing unit 129. The local arm LD is configured to be capable of selectively transporting the substrate W onto any of the plurality of spin chucks 35 of the development processing unit 139.

Further, the upper platform chamber 135 and the lower platform chamber 136 are provided with the plurality of local arms LTP respectively corresponding to the plurality of thermal processing units TP, the plurality of local arms LCP (FIG. 7) respectively corresponding to the plurality of cooling units CP (FIG. 3) and the plurality of local arms LEEW (FIG. 7) respectively corresponding to the plurality of edge exposure units EEW (FIG. 3). In the upper platform chamber 135 and the lower platform chamber 136, each local arm LTP is provided to be adjacent to the corresponding thermal processing unit TP, each local arm LCP is provided to be adjacent to the corresponding cooling unit CP and each local arm LEEW is provided to be adjacent to the corresponding edge exposure unit EEW.

Each local arm LTP in the upper platform chamber 135 transports the substrate W between the platform unit 137 and the corresponding thermal processing unit TP, the local arm LCP in the upper platform chamber 135 (FIG. 7) transports the substrate W between the platform unit 137 and the corresponding cooling unit CP (FIG. 3) and the local arm LEEW in the upper platform chamber 135 (FIG. 7) transports the substrate W between the platform unit 137 and the corresponding edge exposure unit EEW (FIG. 3). Each local arm LTP in the lower platform chamber 136 transports the substrate W between the platform unit 138 and the corresponding thermal processing unit TP, the local arm LCP in the lower platform chamber 136 (FIG. 7) transports the substrate W between the platform unit 138 and the corresponding cooling unit CP (FIG. 3) and the local arm LEEW in the lower platform chamber 136 (FIG. 7) transports the substrate W between the platform unit 138 and the corresponding edge exposure unit EEW (FIG. 3).

When the substrate W is received by each local arm in the upper platform chamber 135 from the platform unit 137, the lifting/lowering device LID of the platform unit 137 (FIG. 4) adjusts the height of the shelf ST such that the height of the substrate W to be received is at the height of which the substrate W can be received by the local arm. Further, when the substrate W is received by the local arms L1, L3 (FIG. 4) from the platform unit 137, the lifting/lowering device LID of the platform unit 137 (FIG. 4) adjust the height of the shelf ST such that the height of the substrate W to be received is at the height of which the substrate W can be received by the local arms L1, L3.

Further, when the substrate W is received by the local arm in the lower platform chamber 136 from the platform unit 138, the lifting/lowering device LID of the platform unit 138 (FIG. 4) adjust the height of the shelf ST such that the height of the substrate W to be received is at the height of which the substrate W can be received by the subject local arm. Further, when the substrate W is received by the local arms L2, L4 (FIG. 4) from the platform unit 138, the lifting/lowering device LID of the platform unit 138 (FIG. 4) adjust the height of the shelf ST such that the height of the substrate W to be received is at the height of which the substrate W can be received by the local arms L2, L4.

(1-5) Operation of the Substrate Processing Apparatus Description will be made of the operation of each constituent element of the substrate processing apparatus 100 according to the present embodiment with reference to FIGS. 1 to 7. In the following description, the upper platform chambers 125, 135, the upper thermal processing sections 301, 303, the coating processing chambers 21, 22, 32 and the development processing chamber 31 are referred to as an upper processing region, and the lower platform chambers 126, 136, the lower thermal processing sections 302, 304, the coating processing chambers 23, 24, 34 and the development processing chamber 33 are referred to as a lower processing region. In the present embodiment, the processing for the substrate W in the upper processing region and the processing for the substrate W in the lower processing region are concurrently performed.

First, the carriers 113 that store the unprocessed substrates W are placed on the carrier platforms 111 in the indexer block 11 (FIG. 1). The substrates W are alternately transported to the shelves ST of the platform unit 127 in the upper platform chamber 125 (FIG. 5) and the shelves ST of the platform unit 128 in the lower platform chamber 126 (FIG. 5) from the carriers 113.

In the following, description will be made of the operation in the upper processing region, and description will not be made of the operation in the lower processing region. The operation in the lower processing region is similar to the operation in the upper processing region.

Each local arm LAHP in the upper platform chamber 125 (FIG. 5) receives the unprocessed substrate W from one of the shelves ST of the platform unit 127 and transports the substrate W to the corresponding adhesion reinforcement processing unit AHP. In each adhesion reinforcement processing unit AHP, the adhesion reinforcement processing for the substrate W is performed. Each local arm LAHP transports the substrate W after the adhesion reinforcement processing from the corresponding adhesion reinforcement processing unit AHP to one of the shelves ST of the platform unit 127.

Each local arm LCP in the upper platform chamber 125 receives the substrate W after the adhesion reinforcement processing from one of the shelves ST of the platform unit 127 and transports the substrate W to the corresponding cooling unit CP. In each cooling unit CP, the substrate W is cooled to a temperature suitable for formation of the anti-reflection film. If the anti-reflection film can appropriately be formed, the cooling processing for the substrate W does not have to be performed before the formation of the anti-reflection film. Each local arm LCP transports the substrate W after the cooling processing from the corresponding cooling unit CP to one of the shelves ST of the platform unit 127.

The local arm LB in the upper platform chamber 125 receives the substrate W after the cooling processing from one of the shelves ST of the platform unit 127, transports the substrate W to the coating processing chamber 22 and places the substrate W on the spin chuck 25 of the coating processing unit 129. In the coating processing chamber 22, the anti-reflection film is formed on the substrate W by the coating processing unit 129. Each local arm LB transports the substrate W after the formation of the anti-reflection film from the coating processing chamber 22 to one of the shelves ST of the platform unit 127.

Each local arm LTP in the upper platform chamber 125 receives the substrate W after the formation of the anti-reflection film from one of the shelves ST of the platform unit 127 and transports the substrate W to the corresponding thermal processing unit TP. In each thermal processing unit TP, the thermal processing for the substrate W after the formation of the anti-reflection film is performed. Each local arm LTP transports the substrate W after the thermal processing from the corresponding thermal unit TP to one of the shelves ST of the platform unit 127.

Each local arm LCP in the upper platform chamber 125 receives the substrate W after the thermal processing from one of the shelves ST of the platform unit 127 and transports the substrate W to the corresponding cooling unit CR. In each cooling unit CP, the substrate W is cooled to a temperature suitable for the formation of the resist film. Each local arm LCP transports the substrate W after the cooling processing from the corresponding cooling unit CP to one of the shelves ST of the platform unit 127.

The local arm LR in the upper platform chamber 125 receives the substrate W after the formation of the anti-reflection film and the cooling processing from one of the shelves ST of the platform unit 127, transports the substrate W to the coating processing chamber 21 and places the substrate W on the spin chuck 25 of the coating processing unit 129. In the coating processing chamber 21, the resist film is formed on the substrate W by the coating processing unit 129. The local arm LR transports the substrate W after the formation of the resist film from the coating processing chamber 21 to one of the shelves ST of the platform unit 127.

Each local arm LTP in the upper platform chamber 125 receives the substrate W after the formation of the resist film from one of the shelves ST of the platform unit 127 and transports the substrate W to the corresponding thermal processing unit TP. In each thermal processing unit TP, the thermal processing for the substrate W after the formation of the resist film is performed. Each local arm LTP transports the substrate W after the thermal processing from the corresponding thermal processing unit TP to one of the shelves ST of the platform unit 127.

The local arm L1 (FIG. 4) receives the substrate W after the formation of the resist film and the thermal processing from one of the shelves ST of the platform unit 127 and transports the substrate W to one of the shelves ST of the platform unit 137.

The local arm LC in the upper platform chamber 135 (FIG. 6) receives the substrate W, after the formation of the resist film and the thermal processing, transported by the local arm L1 from one of the shelves ST of the platform unit 137, transports the substrate W to the coating processing chamber 32 and places the substrate W on the spin chuck 25 of the coating processing unit 129. In the coating processing chamber 32, the resist cover film is formed on the substrate W by the coating processing unit 129. The local arm LC transports the substrate W after the formation of the resist cover film from the coating processing chamber 32 to one of the shelves ST of the platform unit 137.

Each local arm LTP in the upper platform chamber 135 receives the substrate W after the formation of the resist cover film from one of the shelves ST of the platform unit 137 and transports the substrate W to the corresponding thermal processing unit TP. In each thermal processing unit TP, the thermal processing for the substrate W after the formation of the resist cover film is performed. Each local arm LTP transports the substrate W after the thermal processing from the corresponding thermal processing unit TP to one of the shelves ST of the platform unit 137.

The local arm LEEW in the upper platform chamber 135 receives the substrate W after the formation of the resist cover film and the thermal processing from one of the shelves ST of the platform unit 137 and transports the substrate W to the corresponding edge exposure unit EEW. In the edge exposure unit EEW, the edge exposure processing for the substrate W is performed. The local arm LEEW transports the substrate W after the edge exposure processing from the corresponding edge exposure unit EEW to one of the shelves ST of the platform unit 137.

The local arm L3 (FIG. 4) receives the substrate W after the edge exposure processing from one of the shelves ST of the platform unit 137 and transports the substrate W to the transport section 163 in the interface block 14. The substrate W after the edge exposure processing that has been transported to the transport section 163 in the interface block 14 is carried into the exposure device 15 (FIG. 1) by the transport mechanism (not shown) after the cleaning processing and the drying processing are performed in one of the cleaning/drying processing units SD1 in the cleaning/drying processing section 161.

In the exposure device 15, the exposure processing by the liquid immersion method is performed. The substrate W after the exposure processing is carried out from the exposure device 15 by the transport mechanism (not shown) and the cleaning processing and the drying processing are performed in one of the cleaning/drying processing units SD2 in the cleaning/drying processing section 162. The local arm L3 (FIG. 4) transports the substrate W after the cleaning processing and drying processing by the cleaning/drying processing unit SD2 to one of the shelves ST of the platform unit 137.

Each local arm LTP in the upper platform chamber 135 (FIG. 6) receives the substrate W after the exposure processing from one of the shelves ST of the platform unit 137 and transports the substrate W to the corresponding thermal processing unit TP. In each thermal processing unit TP, post-exposure bake (PEB) processing is performed. Each local arm LTP transports the substrate W after the PEB processing from the corresponding thermal processing unit TP to one of the shelves ST of the platform unit 137. Note that the thermal processing unit TP for performing the post-exposure bake processing may be provided in the interface block 14. In this case, a time period from the time when the exposure processing is performed on each substrate W to the time when the post-exposure bake processing is performed on the substrate W is shortened. Further, the time period is inhibited from having variations. Therefore, even better exposure pattern can be obtained.

Each local arm LCP in the upper platform chamber 135 receives the substrate W after the PEB processing from one of the shelves ST of the platform unit 137 and transports the substrate W to the corresponding cooling unit CP. In each cooling unit CP, the substrate W is cooled to a temperature suitable for the development processing. Note that, if the development processing can be appropriately performed, the cooling processing for the substrate W does not have to be performed before the development processing. Each local arm LCP transports the substrate W after the cooling processing from the corresponding cooling unit CP to one of the shelves ST of the platform unit 137.

The local arm LD in the upper platform chamber 135 receives the substrate W after the cooling processing from one of the shelves ST of the platform unit 137, transports the substrate W to the development processing chamber 31 and places the substrate W on the spin chuck 35 of the development processing unit 139. In the development processing chamber 31, removal processing of the resist cover film and the development processing are performed by the development processing unit 139. The local arm LD transports the substrate W after the development processing from the development processing chamber 31 to one of the shelves ST of the platform unit 137.

Each local arm LTP in the upper platform chamber 135 receives the substrate W after the development processing from one of the shelves ST of the platform unit 137 and transports the substrate W to the corresponding thermal processing unit TP. In each thermal processing unit TP, the thermal processing for the substrate W after the development processing is performed. Each local arm LTP transports the substrate W after the thermal processing from the corresponding thermal processing unit TP to one of the shelves ST of the platform unit 137.

The local arm L1 (FIG. 4) receives the substrate W after the development processing and the thermal processing from one of the shelves ST of the platform unit 137 and transports the substrate W to one of the shelves ST of the platform unit 127. The transport mechanism 115 (FIG. 1) receives the substrate W after the development processing and the thermal processing from one of the shelves ST of the platform unit 127 and transports the substrate W to one of the carriers 113.

Also in the lower processing region, the processing for the substrate W is performed similarly to the upper processing region. In the lower processing region, the substrate W after the development processing and the thermal processing is transported to one of the shelves ST of the platform unit 128. The transport mechanism 115 receives the substrate W after the development processing and the thermal processing from one of the shelves ST of the platform unit 128 and transports the substrate W to one of the carriers 113. In such a way, series of processing for each substrate W is completed.

(1-6) Effects

In the substrate processing apparatus 100 according to the present embodiment, in the first processing block 12, the substrates W are transported between the platform section 122 and the coating processing section 121 by the local arms LR, LB, and the substrates W are transported between the platform section 122 and the thermal processing section 123 by the local arms LTP,

LAHP, LCP. Further, in the second processing block 13, the substrates W are transported between the platform section 132 and the coating/development processing section 131 by the local arms LD, LC, and the substrates W are transported between the platform section 132 and the thermal processing section 133 by the local arms LTP, LCP, LEEW.

Thus, in the first processing block 12, the transportation of the substrates W between the platform section 122 and the coating/processing section 121 and the transportation of the substrates W between the platform section 122 and the thermal processing section 123 are performed by the different local arms, respectively. Further, in the second processing block 13, the transportation of the substrates W between the platform section 132 and the coating/development processing section 131 and the transportation of the substrates W between the platform section 132 and the thermal processing section 133 are performed by the different local arms, respectively. This causes the transport efficiency of the substrates W to the coating processing section 121, the coating/development processing section 131 and the thermal processing sections 123, 133 to increase. As a result, the throughput is improved.

Further, because the transportation of the substrates W to the thermal processing sections 123, 133 and the transportation of the substrates W to the coating processing section 121 and the coating/development processing section 131 are respectively performed by the different local arms, the accumulated heat in the local arms generated at the time of the transportation of the substrates W to the thermal processing sections 123, 133 does not influence at the time of the transportation of the substrates W to the coating processing section 121 and the coating/development processing section 131. Therefore, the coating processing and the development processing for the substrates W can be performed at appropriate temperatures.

Further, in the present embodiment, in the upper platform chamber 125 and the lower platform chamber 126 in the platform section 122, and the upper platform chamber 135 and the lower platform chamber 136 in the platform section 132, the plurality of substrates W can be placed on the shelves ST arranged in multiple stages of the platform units. Thus, the plurality of substrates W can be efficiently transported to the coating processing section 121, the coating/development processing section 131 and the thermal processing sections 123, 133 without increasing the occupied area of the platform sections 122, 132.

Further, in the present embodiment, the coating processing section 121 includes the plurality of coating processing units 129 arranged one above the other in the vertical direction, and the coating/development processing section 131 includes the plurality of coating processing units 129 and the development processing units 139 arranged one above the other in the vertical direction. Thus, the coating processing can be simultaneously performed on the plurality of substrates W in the plurality of coating processing units 129 without increasing the occupied area of the coating processing section 121. Further, the coating processing and the development processing can be simultaneously performed on the plurality of substrates W in the plurality of coating processing units 129 and the development processing units 139 without increasing the occupied area of the coating/development processing section 131. Thus, the throughput is further improved.

Further, in the present embodiment, the plurality of local arms LR, LB, LD, LC are provided to correspond to the plurality of coating processing units 129 and the plurality of development processing units 139, respectively. Thus, the substrates W can be efficiently transported to the plurality of coating processing units 129 and the plurality of development processing units 139.

Further, in the present embodiment, the thermal processing section 123 includes the plurality of thermal processing units TP, the plurality of adhesion reinforcement processing units AHP and the plurality of cooling units CP arranged one above the other in the vertical direction, and the thermal processing section 133 includes the plurality of thermal processing units TP, the plurality of edge exposure units EEW and the plurality of cooling units CP arranged one above the other in the vertical direction. Thus, the thermal processing can be simultaneously performed on the plurality of substrates W in the plurality of thermal processing units TP, the plurality of adhesion reinforcement processing units AHP and the plurality of cooling units CP without increasing the occupied area of the thermal processing section 123. Further, the thermal processing can be simultaneously performed on the plurality of substrates W in the plurality of thermal processing units TP, the plurality of edge exposure units EEW and the plurality of cooling units CP without increasing the occupied area of the thermal processing section 133. Thus, the throughput is further improved.

Further, in the present embodiment, the plurality of local arms LTP, LAHP, LCP, LEEW are provided to correspond to the plurality of thermal processing units TP, the plurality of adhesion reinforcement processing units AHP, the plurality of cooling units CP and the plurality of edge exposure units EEW, respectively. Thus, the substrates W can be efficiently transported to the plurality of thermal processing units TP, the plurality of adhesion reinforcement processing units AHP, the plurality of cooling units CP and the plurality of edge exposure units EEW.

Further, in the present embodiment, each of the platform units 127, 128, 137, 138 includes the lifting/lowering device LID for lifting/lowering the shelves ST arranged in multiple stages. This enables the height of each substrate W placed on each shelf ST to be adjusted to the height of which the substrate W can be received by each local arm. Thus, the operation of each local arm can be simplified.

Further, when the transportation between the plurality of processing units is performed by the common transport mechanism, frequency and a time period for the maintenance becomes significant because of a heavy burden on the transport mechanism. Further, because the transport speed of the substrate W needs to increase in order to improve the throughput, a risk of dropping the substrate W is high. In contrast, in the present embodiment, because the local arm is provided for each processing unit, the burden on each local arm is reduced and the frequency and the time period for the maintenance can be reduced. Further, because the operation of each local arm is simplified and the transport speed of the substrate W can be suppressed, the risk of dropping the substrate W is reduced.

### (2) Second Embodiment

As for the substrate processing apparatus 100 according to the second embodiment of the present invention, the differences from the substrate processing apparatus 100 according to the first embodiment will be described.

(2-1) Configuration of the Platform Section

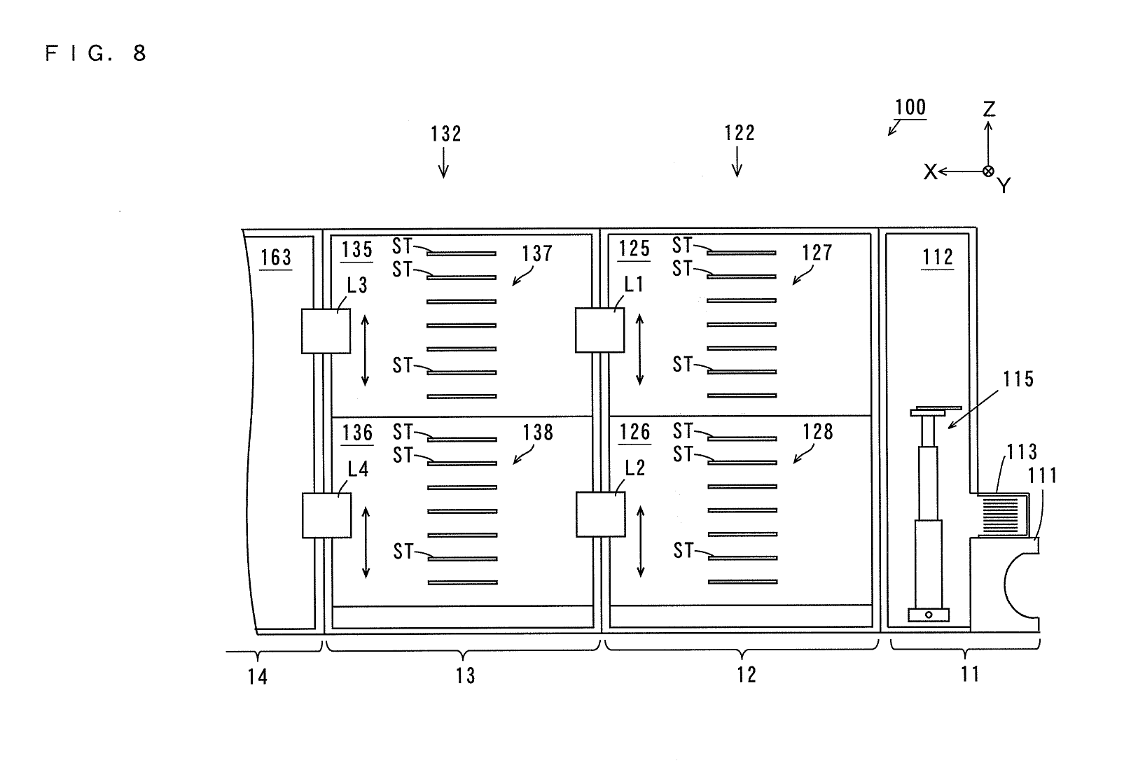

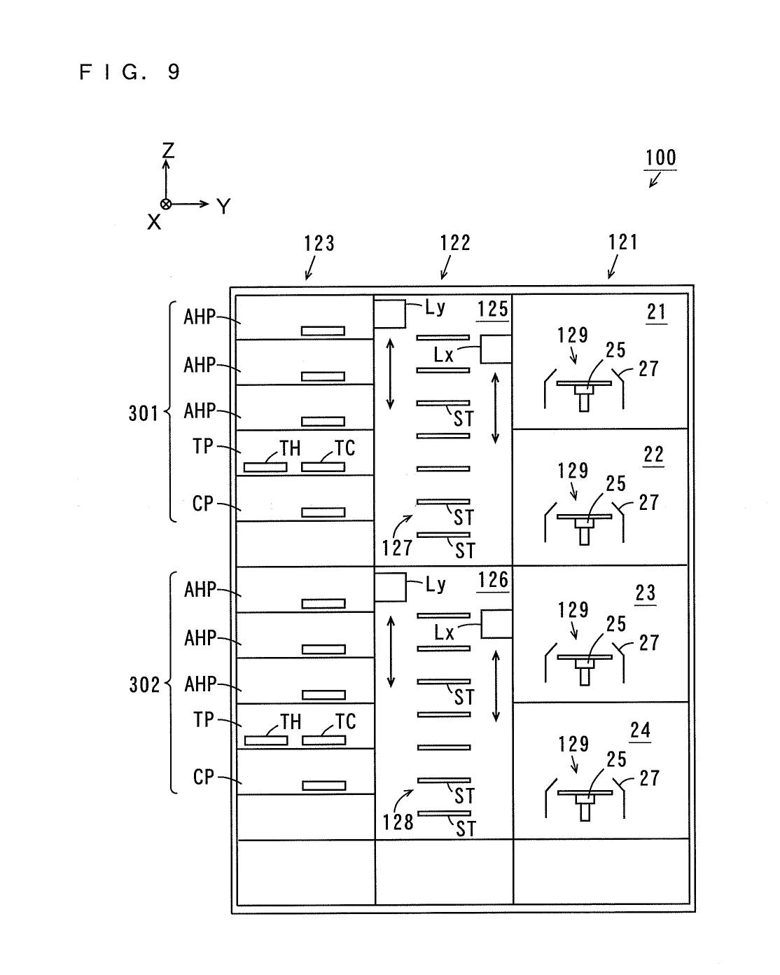

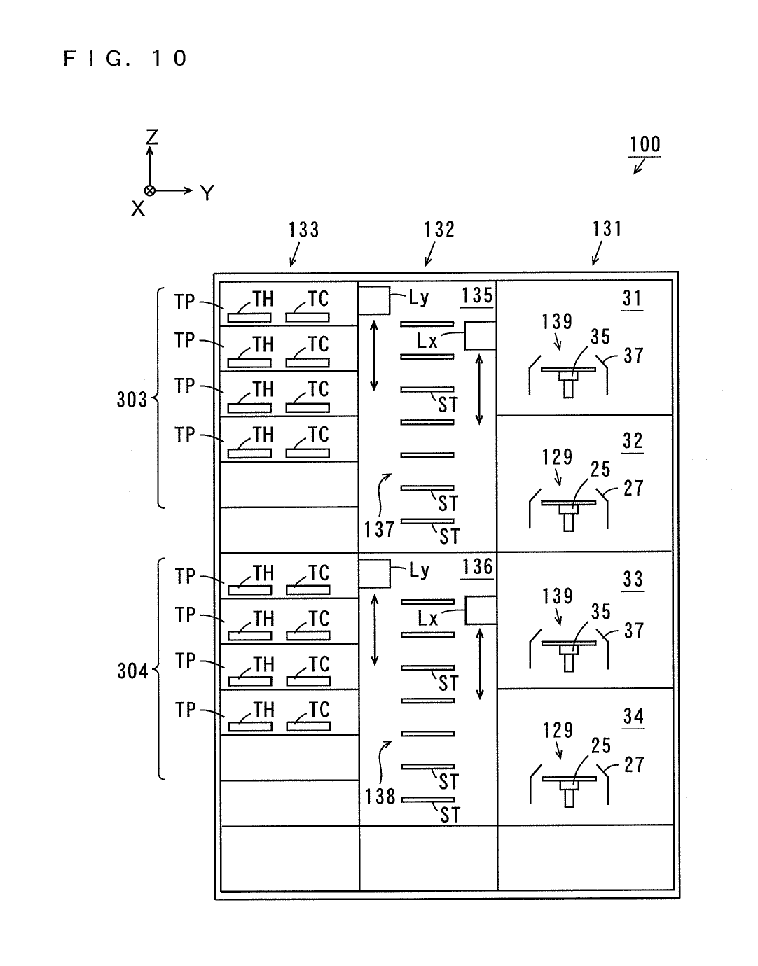

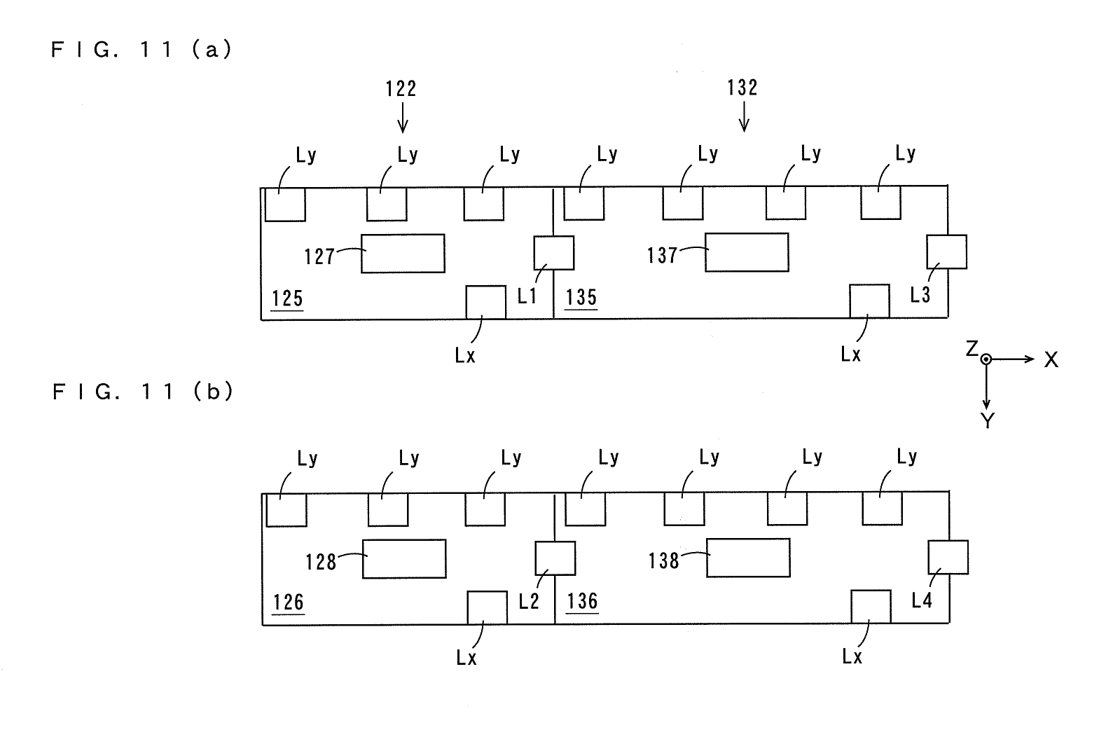

FIG. 8 is a schematic side view of the platform sections 122, 132. FIG. 9 is a schematic side view of the coating processing section 121, the platform section 122 and the thermal processing section 123. FIG. 10 is a schematic side view of the coating/development processing section 131, the platform section 132 and the thermal processing section 133. FIG. 11 is a schematic plan view of the platform sections 122, 132. Note that, FIG. 11(a) shows the upper platform chambers 125, 135, and FIG. 11(b) shows the lower platform chambers 126, 136.

As shown in FIG. 8, each of the platform units 127, 128, 137, 138 does not have the lifting/lowering device LID. Therefore, the height of each shelf ST of the platform units 127, 128, 137, 138 is fixed. Each of the local arms L1 to L4 is configured to be vertically movable.

As shown in FIG. 9, each of the upper platform chamber 125 and the lower platform chamber 126 is provided with a local arm Lx instead of the local arms LR, LB, and with a plurality of local arms Ly instead of the plurality of local arms LTP, LAHP, LCP. As shown in FIG. 11, each local arm Ly in the upper platform chamber 125 corresponds to each row in the upper thermal processing section 301, and each local arm Ly in the lower platform chamber 126 corresponds to each row in the lower thermal processing section 302. The local arms Lx, Ly are configured to be vertically movable, respectively.

The local arm Lx in the upper platform chamber 125 transports the substrate W between the platform unit 127 and the coating processing chamber 21 and between the platform unit 127 and the coating processing chamber 22 while moving in the vertical direction. Each local arm Ly in the upper platform chamber 125 transports the substrate W between the platform unit 127 and each unit of the corresponding row in the upper thermal processing 301 while moving in the vertical direction.

The local arm Lx in the lower platform chamber 126 transports the substrate W between the platform unit 128 and the coating processing chamber 23 and between the platform unit 128 and the coating processing chamber 24 while moving in the vertical direction. Each local arm Ly in the lower platform chamber 126 transports the substrate W between the platform unit 128 and each unit of the corresponding row in the lower thermal processing section 302 while moving in the vertical direction.

As shown in FIG. 10, in each of the upper platform chamber 135 and the lower platform chamber 136, a local arm Lx is provided instead of the local arms LD, LC, and a plurality of local arms Ly are provided instead of the plurality of local arms LTP, LCP, LEEW. As shown in FIG. 11, each local arm Ly in the upper platform chamber 135 corresponds to each row in the upper thermal processing section 303, and each local arm Ly in the lower platform chamber 136 corresponds to each row in the lower thermal processing section 304.

The local arm Lx in the upper platform chamber 135 transports the substrate W between the platform unit 137 and the development processing chamber 31 and between the platform unit 137 and the coating processing chamber 32 while moving in the vertical direction. Each local arm Ly in the lower platform chamber 135 transports the substrate W between the platform unit 137 and each unit of the corresponding row in the upper thermal processing section 303 while moving in the vertical direction.

The local arm Lx in the lower platform chamber 136 transports the substrate W between the platform unit 138 and the development processing chamber 33 and between the platform unit 138 and the coating processing chamber 34 while moving in the vertical direction. Each local arm Ly in the lower platform chamber 136 transports the substrate W between the platform unit 138 and each unit of the corresponding row in the lower thermal processing section 304 while moving in the vertical direction.

Thus, in the present embodiment, because the local arms Lx, Ly can move in the vertical direction, the substrate W can be transported between each platform unit and each processing chamber and between each platform unit and each unit in each thermal processing section without lifting/lowering each shelf ST of each platform unit. Therefore, the configuration of each platform unit can be simplified. Further, because the number of the local arms can be reduced, a cost can be reduced.

### (2-2) Modified Examples

(2-2-1)

While one local arm Ly is provided for each row in the upper thermal processing sections 301, 303 and the lower thermal processing sections 302, 304 in the examples of FIGS. 8 to 11, the invention is not limited to this. One local arm Ly may be provided for each of the upper thermal processing sections 301, 303 and the lower thermal processing sections 302, 304. In this case, each local arm Ly is provided to be movable in the vertical direction and the X direction. Further, not less than the two local arms Ly may be provided for each row in the upper thermal processing sections 301, 303 and the lower thermal processing sections 302, 304.

(2-2-2)

In the examples of FIGS. 8 to 11, the platform units 127, 128, 137, 138 may have lifting/lowering mechanisms LID, respectively. In this case, both the height of which the substrate W can be received by each local arm and the height of the substrate W placed on the one of the shelves ST of each platform unit can be adjusted. Therefore, receipt of the substrate W from each platform unit by each local arm and the transportation of the substrate W to each platform unit by each local arm can be efficiently performed.

(3) Yet Another Embodiment

(3-1)

While the local arm corresponding to each unit in each processing chamber and each thermal processing section is provided in the upper platform sections 125, 135 and lower platform chambers 126, 136 in the first and second embodiments described above, the invention is not limited to this. For example, the corresponding local arm may be provided for each unit in each processing chamber or in each unit in each thermal processing section.

(3-2)

The one platform unit 127, 128, 137, 138 is respectively provided in each of the upper platform chambers 125, 135 and the lower platform chambers 126, 136 in the first and second embodiments described above, the invention is not limited to this. Not less than the two platform units may be provided in each of the upper platform chambers 125, 135 and the lower platform chambers 126, 136. Further, in this case, in each of the upper platform chambers 125, 135 and the lower platform chambers 126, 136, the local arm for transporting the substrate W among the plurality of platform units may be separately provided.

(3-3)

Similarly to the platform sections 122, 132 in the first and second processing blocks 12, 13, the platform unit and the plurality of local arms may be provided in the transport section 163 in the interface block 14. In this case, the transport efficiency of the substrate W in the interface block 14 can be enhanced.

(3-4)

While the first and second embodiments described above are examples of the substrate processing apparatus, arranged to be adjacent to the exposure device that performs exposure processing by the liquid immersion method and, performs the film forming processing and the development processing for the substrate W, the present invention is not limited to this. For example, this invention may be applied to the substrate processing apparatus, arranged to be adjacent to the exposure device that performs the exposure processing under a dry atmosphere without using liquid, that performs the film forming processing and the development processing for the substrate W. Further, the present invention may be applied to the substrate processing apparatus that performs only the film forming processing and the thermal processing for the substrate W, the substrate processing apparatus that performs only the development processing and the thermal processing for the substrate W or the like.

(4) Correspondences between Constituent Elements in Claims and Parts in Preferred Embodiments

In the following paragraphs, non-limiting examples of correspondences between various elements recited in the claims below and those described above with respect to various preferred embodiments of the present invention are explained.

In the embodiment described above, the substrate processing apparatus 100 is an example of a substrate processing apparatus, the first processing block 12 is an example of a processing section, the indexer block 11 is an example of a carry-in/carry-out section, the coating processing section 121 is an example of a liquid processing section, the thermal processing section 123 is an example of a thermal processing section, the platform section 122 is an example of a platform section, the local arms LB, LR are examples of a first transport mechanism and a first transport unit, and the local arms LTP, LAHP, LCP are examples of a second transport mechanism and a second transport unit, the carrier platform 111 is an example of a container platform and the transport mechanism 115 is an example of the third transport mechanism.

Further, the coating processing unit 129 is an example of a liquid processing unit, the thermal processing unit TP, the adhesion reinforcement processing unit AHP and the cooling unit CP are examples of a thermal processing unit and the lifting/lowering device LID is an example of a lifting/lowering mechanism.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/we claim:

1. A substrate processing apparatus comprising:
a processing section; and
a carry-in/carry-out section for carrying in/out a substrate to/from the processing section, wherein
the processing section and the carry-in/carry-out section are arranged in one direction,
the processing section includes
a liquid processing section for performing liquid processing using a processing liquid on the substrate,
a thermal processing section for performing thermal processing on the substrate,
a platform section for temporarily placing the substrate,
a first transport mechanism configured to transport the substrate between the platform section and the liquid processing section and
a second transport mechanism configured to transport the substrate between the platform section and the thermal processing section, and
the liquid processing section is arranged on one side of the platform section and the thermal processing section is arranged on another side of the platform section in the one direction, and the liquid processing section, the platform section and the thermal processing section are arranged in the one direction, and
the carry-in/carry-out section includes
a container platform on which a storing container storing the substrate is placed, and
a third transport mechanism configured to transport the substrate between the storing container placed on the container platform and the platform section in the processing section.

2. The substrate processing apparatus according to claim 1, wherein
the platform section is configured such that the plurality of substrates can be placed one above the other in a vertical direction.

3. The substrate processing apparatus according to claim 1, wherein
the liquid processing section includes a plurality of liquid processing units arranged one above the other in a vertical direction.

4. The substrate processing apparatus according to claim 3, wherein
the first transport mechanism includes one or a plurality of first transport units, and
each first transport unit corresponds to at least one of the plurality of liquid processing units and is configured to transport the substrate between the corresponding liquid processing unit and the platform section.

5. The substrate processing apparatus according to claim 4, wherein
at least the one first transport unit is configured to be vertically movable.

6. The substrate processing apparatus according to claim 1, wherein
the thermal processing section includes a plurality of thermal processing units arranged one above the other in a vertical direction.

7. The substrate processing apparatus according to claim 6, wherein
the second transport mechanism includes one or a plurality of second transport units, and
each second transport unit corresponds to at least one of the plurality of thermal processing units and is configured to transport the substrate between the corresponding thermal processing unit and the platform section.

8. The substrate processing apparatus according to claim 7, wherein
at least the one second transport unit is configured to be vertically movable.

9. The substrate processing apparatus according to claim 1, further comprising:
a lifting/lowering mechanism configured to vertically move the substrate placed in the platform section.
